(19) United States
(12) Patent Application Publication
(10) Pub. No.: US 2006/0278266 A1
(43) Pub. Date: Dec. 14, 2006

(54) Solar energy device and electronic device employing the same

(75) Inventor: Hsin-Ho Lee, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/409,937

(22) Filed: Apr. 24, 2006

(30) Foreign Application Priority Data
Jun. 8, 2005 (CN) 200510035215.8

(51) Int. Cl. H02N 6/00

(52) U.S. Cl. 136/246

(57) ABSTRACT

A solar energy device (100) for an electronic device includes a solar energy collecting component (10) and a lens module (20). The solar energy collecting component has a first surface (105) and a second surface. The lens module is rotatably mounted relative to the solar energy collecting component. The lens module is configured to concentrate incident solar radiation onto the first surface of the solar energy collecting component. The solar energy collecting component is for converting incident solar radiation energy to electrical energy. The lens module is movable between a first position in which the lens module is spaced from the first surface of the solar energy collecting component so as to concentrate incident solar radiation onto the first surface and a second position in which the lens module abuts the second surface so as to reduce overall volume of the solar energy device.

### BACKGROUND OF THE INVENTION

1. Field of the Invention

The present invention generally relates to solar energy devices and, more particularly, to a solar energy device for use in a portable electronic device.

2. Discussion of the Related Art

With the development of wireless communication and information processing technologies, portable electronic devices such as mobile telephones and electronic notebooks are now in widespread use. These electronic devices enable consumers to enjoy high technology services anytime and anywhere.

Many portable electronic devices are equipped with rechargeable batteries. The batteries can be recharged through a power conversion adapter used in conjunction with household alternating current (AC) power or through a power conversion adapter used in conjunction with a 12-volt cigarette lighter socket provided in an automobile. However, when a user is away from such a power source, it is hard to recharge the battery.

It is well known that single crystal silicon photovoltaic cells, or silicon solar cells, have been successfully employed to convert incident solar radiation energy into electrical energy. The silicon solar cells are in extensive common use primarily because they provide relatively high conversion efficiencies compared to other energy conversion devices that are presently available. However, the cost of the silicon solar cells has been a predominant system cost factor. Now it has been recognized that cost savings can be achieved by using concentrators or reflectors to increase the intensity of incident radiation, thus providing increased power outputs per unit solar cell area. However, when using a concentrator, there is generally a space between the concentrator and the silicon solar cell in order to achieve high intensity of the incident radiation. Correspondingly, the volume of the silicon solar cells system is large and awkward to carry.

Therefore, a new solar energy device is desired in order to overcome the above-described shortcomings.

### SUMMARY OF THE INVENTION

In one aspect, a solar energy device is provided for an electronic device. The solar energy device includes a solar energy collecting component and a lens module. The solar energy collecting component has a first surface and a second surface. The lens module is rotatably mounted relative to the solar energy collecting component. The lens module is configured to concentrate incident solar radiation onto the first surface of the solar energy collecting component. The solar energy collecting component is for converting incident solar radiation energy to electrical energy. The lens module is movable between a first position in which the lens module is spaced from the first surface of the solar energy collecting component so as to concentrate incident solar radiation onto the first surface and a second position in which the lens module abuts the second surface so as to reduce overall volume of the solar energy device.

In another aspect, an electronic device employing a solar energy device is provided. The electronic device includes a device body, a battery, and a solar energy device. The battery and the solar energy device are mounted to the device body. The battery has a battery connector. The solar energy device includes a solar energy collecting component and a lens module. The lens module is configured to concentrate incident solar radiation onto the solar energy collecting component. The solar energy collecting component is for converting incident solar radiation energy to electrical energy and is electrically connected with the battery connector. The lens module is rotatable relative to the solar energy collecting component.

Other advantages and novel features of the embodiments will become more apparent from the following detailed description thereof when taken in conjunction with the accompanying drawings.

### BRIEF DESCRIPTION OF THE DRAWINGS

Many aspects of the present solar energy device can be better understood with reference to the following drawings. The components in the drawings are not necessarily drawn to scale, the emphasis instead being placed upon clearly illustrating the principles of the solar energy device and its potential applications. Moreover, in the drawings, like reference numerals designate corresponding parts throughout the several views.

FIG. 1 is an assembled, isometric view of a solar energy device in accordance with a preferred embodiment of the present invention;

FIG. 2 is an exploded view of the solar energy device in FIG. 1;

FIG. 3 is a partly assembled, isometric view of the solar energy device in FIG. 1;

FIG. 4 is an assembled, isometric view of the solar energy device used with a mobile phone; and

FIG. 5 is an isometric view of an electronic device with a solar energy device in a use position in accordance with another preferred embodiment of the present invention.

### DETAILED DESCRIPTION OF THE EMBODIMENTS

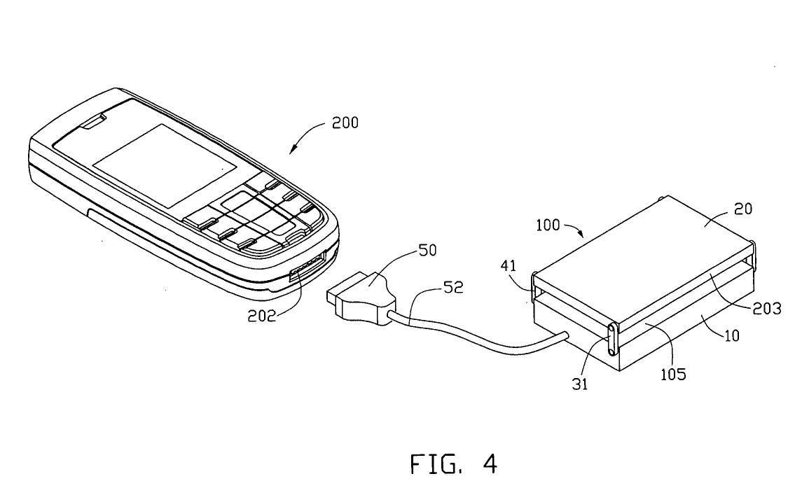

Referring now to the drawings in detail, FIG. 4 shows a solar energy device 100 for use with a mobile phone 200. The mobile phone 200 is taken here as an exemplary application, for the purposes of describing details of the solar energy device 100 of a preferred embodiment of the present invention. It is to be understood, however, that the solar energy device 100 could be suitably used in other environments (e.g. electronic notebooks). As such, although proving particularly advantageous when used in the mobile phone 200, the solar energy device 100 should not be considered limited in scope solely to an intended use environment of the mobile phone 200. The mobile phone 200 has a charging socket 202 formed at one end thereof for electronically connecting with the solar energy device 100.

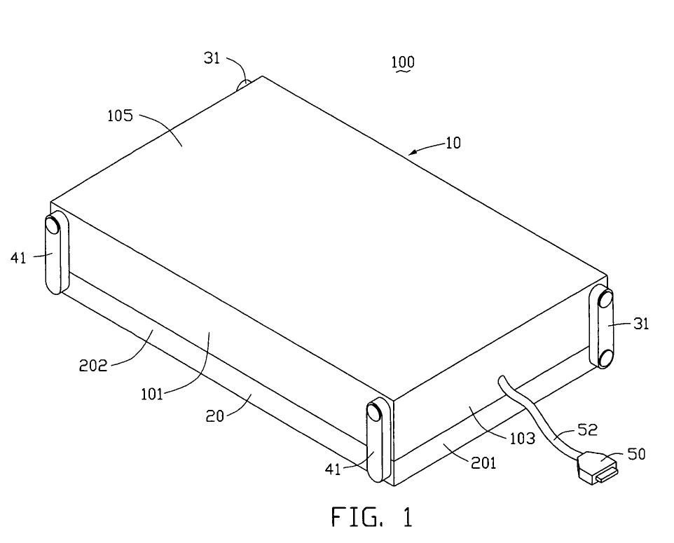

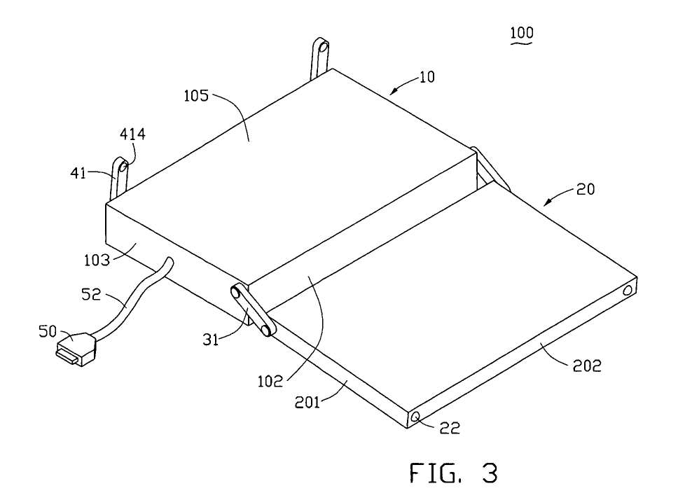

Also referring to FIGS. 1-3, the solar energy device 100 includes a solar energy collecting component 10, a lens module 20, a pair of rotating poles 31, a pair of positioning poles 41, and a plug connector 50. The lens module 20 is rotatable relative to the solar energy collecting component 10 through the cooperation of the rotating poles 31 and the positioning poles 41. The plug connector 50 is electrically connected with the solar energy collecting component 10 through a transmission line 52. The plug connector 50 is configured to engage with the charging socket 202 of the mobile phone 200 in order to recharge a battery (not shown) in the mobile phone 200 through the solar energy device 100.

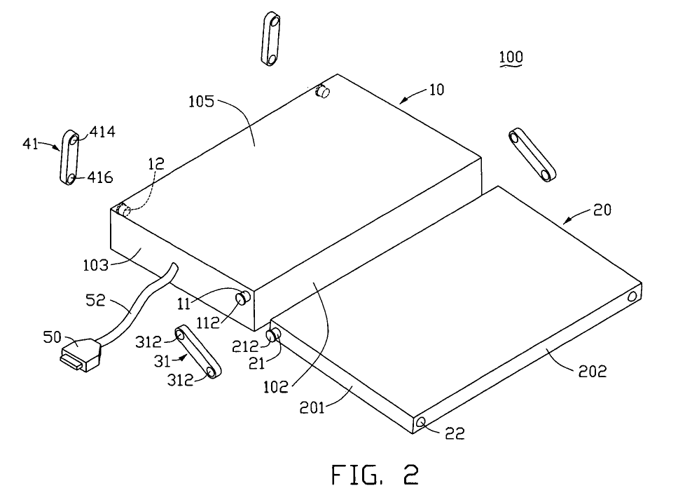

Further referring to FIGS. 1-2, the solar energy collecting component 10 is for converting incident solar radiation energy into electrical energy. The solar energy collecting component 10 is substantially in the form of a cuboid and has a first major sidewall 101, a second major sidewall 102 opposed to the first major sidewall 101, a pair of opposite minor sidewalls 103, a top surface 105, and a bottom surface (not shown) opposed to the top surface 105. A columnar first mounting shaft 11 is formed at each of the two opposite minor sidewalls 103, both adjacent to the second major sidewall 102 and the top surface 105. A first flange 112 is formed at each distal end of the first mounting shafts 11. A diameter of the first flange 112 is slightly larger than a diameter of the first mounting shaft 11. A columnar second mounting shaft 12 is formed at each of two opposite ends of the first major sidewall 101, respectively adjacent to the two opposite minor sidewalls 103 and both adjacent to the top surface 105. The shape and size of second mounting shafts 12 are similar to those of the first mounting shaft 11. A second flange (not labeled) is formed at each distal end of the second mounting shafts 12. A diameter of the second flange of the second mounting shaft 12 is slightly larger than a diameter of the second mounting shaft 12. A plurality of silicon solar cells are provided at the top surface 105 for collecting incident solar radiation energy and converting incident solar radiation energy into electrical energy.

Further referring to FIG. 4, the lens module 20 is a Fresnel lens module in the present embodiment. The lens module 20 is configured to concentrate incident solar radiation onto the silicon solar cells of the solar energy collecting component 10. The lens module 20 is substantially in the form of a cuboid and has a pair of opposite short sidewalls 201, a first long sidewall 202, a second long sidewall 203 opposed to the first long sidewall 202, a top surface (not labeled), and a bottom surface (not labeled) opposed to the top surface. The area of the top surface of the lens module 20 is substantially equal to the area of the top surface 105 of the solar energy collecting component 10. A third mounting shaft 21 is formed at each of the two opposite short sidewalls 201, both adjacent to the second long sidewall 203. The shape and size of the third mounting shaft 21 are similar to those of the first mounting shaft 11. A third flange 212 is formed at each distal end of the third mounting shafts 21. A diameter of the third flange 212 of the third mounting shaft 21 is slightly larger than a diameter of the third mounting shaft 21. A positioning projection 22 is formed at each of two opposite ends of the first long sidewall 202.

The rotating pole 31 is substantially rectangular in shape and has first mounting holes 312 defined in either end. A diameter of the first mounting hole 312 is slightly larger than the diameter of the first mounting shaft 11 of the solar energy collecting component 10 and the diameter of the third mounting shaft 21 of the lens module 20. The diameter of the first mounting hole 312 is slightly smaller than the first flange 112 of the solar energy collecting component 10 and the diameter of the third flange 212 of the lens module 20. The first flanges 112 and the third flanges 212 are respectively forced to travel through the first mounting holes 312 of the rotating poles 31. As a result, the rotating poles 31 are mounted with the solar energy collecting component 10 and the lens module 20, and are rotatable relative to the solar energy collecting component 10 and the lens module 20. The lens module 20 has a first position in which the lens module 20 is located above the top surface 105 of the solar energy collecting component 10 (as best seen in FIG. 4) and a second position in which the lens module 20 is located below the bottom surface of the solar energy collecting component 10 (as best seen in FIG. 1).

The positioning pole 41 is similar to the rotating pole 31. The positioning pole 41 defines a positioning hole 414 in one end thereof and a second mounting hole 416 through the other opposite end thereof. The positioning hole 414 is configured for receiving the positioning projection 22 of the lens module 20. A diameter of the second mounting hole 416 is slightly larger than the diameter of the second mounting shaft 12 of the solar energy collecting component 10 and is slightly smaller than the second flange of the solar energy collecting component 10. The second flanges are respectively forced to travel through the second mounting holes 416 of the positioning poles 41. As a result, the positioning poles 41 are mounted with the solar energy collecting component 10, and are rotatable relative to the solar energy collecting component 10.

Referring to FIG. 4, when the solar energy device 100 is in use, the lens module 20 is in the first position. The lens module 20 is above the top surface 105 of the solar energy collecting component 10. The positioning projections 22 are received in their corresponding positioning holes 414 of the positioning poles 41 in order to supporting the lens module 20. The rotatating poles 31 and the positioning poles 41 are configured to enable the top surface 105 of the solar energy collecting component 10 to be positioned at a focal distance of the lens module 20 in order to increase the intensity of incident radiation. The plug connector 50 is electrically connected with the charging socket 202 of the mobile phone 200 in order to recharge the battery in the mobile phone 200 through the solar energy device 100.

Further referring to FIG. 1, when the solar energy device 100 is not in use, one end of the positioning poles 41 having the positioning holes 414 is rotated away from the lens module 20 and towards the bottom surface of the solar energy collecting component 10. In this process, the positioning projections 22 of the lens module 20 are respectively moved out from engagement with the positioning holes 414. The lens module 20 is rotated away from the top surface 105 of the solar energy collecting component 10 and towards the bottom surface of the solar energy collecting component 10 by means of the rotating poles 31. The positioning holes 414 move into engagement with the positioning projections 22 again to position the lens module 20. The lens module 20 is thus moved into its second position. The rotating poles 31 and the positioning poles 41 are configured to enable the lens module 20 to abut with the solar energy collecting component 10. The volume of the solar energy device 100 in the second position is much smaller than that in the first position such that the solar energy device 100 is convenient to carry.

It is to be understood that the one of the rotating poles 31 may be omitted. Correspondingly, the mounting shafts 11 and 21 may be omitted, too. One of the positioning poles 41 may be omitted, and one of the mounting shafts 12 may correspondingly also be omitted. The plug connector 50 may be any of the many interface configurations suitable for connection to the mobile phone 200 manufactured by different companies.

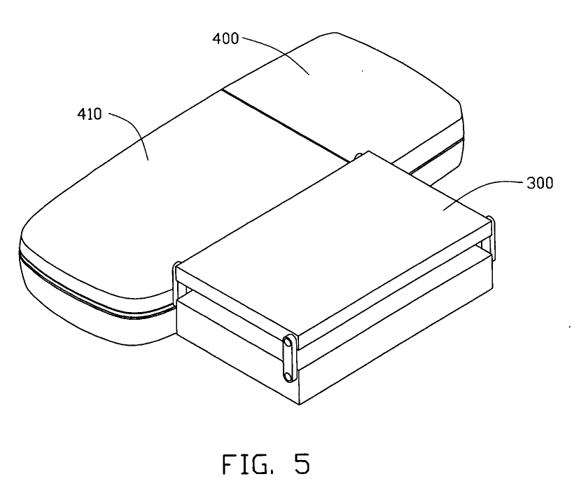

The solar energy device may be directly mounted to the mobile phone. Referring to FIG. 5, one solar energy device 300 is mounted with a mobile phone 400, being electrically connected and located adjacent to a battery 410 thereof, and the solar energy device 300 is in a use position. The solar energy device 300 has a substantially same configuration as that of the solar energy device 100 as shown in FIG. 1. Understandably, in this case, the plug connector 50 and the charging socket 202 may be omitted, and the solar energy collecting component 10 is connected to a battery connector of the mobile phone 400, either directly or via another connector.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A solar energy device comprising;
a solar energy collecting component having a first surface and a second surface; and
a lens module mounted relative to the solar energy collecting component, being configured to concentrate incident solar radiation onto the first surface of the solar energy collecting component;
wherein the solar energy collecting component is configured for converting incident solar radiation energy into electrical energy, and the lens module is movable between a first position in which the lens module is spaced from the first surface of the solar energy collecting component so as to concentrate incident solar radiation onto the first surface and a second position in which the lens module abuts the second surface so as to reduce overall volume of the solar energy device.

2. The solar energy device as claimed in claim 1, further comprising a rotating pole, wherein one end of the rotating pole is mounted on the solar energy collecting component and is rotatable relative to the solar energy collecting component, and the other end of the rotating pole is mounted on the lens module and is rotatable relative to the lens module.

3. The solar energy device as claimed in claim 2, wherein the solar energy collecting component forms a first mounting shaft, a first flange is formed at a distal end of the first mounting shaft, the lens module forms a second mounting shaft, a second flange is formed at a distal end of the second mounting shaft, the rotating pole defines a pair of mounting holes, the two flanges are forced to travel through the two mounting holes, and the rotating pole is mounted on the solar energy collecting component and the lens module.

4. The solar energy device as claimed in claim 2, further comprising a positioning pole, wherein one end of the positioning pole is mounted on the solar energy collecting component and is rotatable relative to the solar energy collecting component, and the other end of the positioning pole is for holding the lens module.

5. The solar energy device as claimed in claim 4, wherein the positioning pole defines a positioning hole in the other end thereof, the lens module defines a positioning projection thereon, and the positioning projection is configured to be mounted in the positioning hole thereby the positioning pole holding the lens module.

6. The solar energy device as claimed in claim 1, wherein the first surface of the solar energy collecting component is opposite to and faces away from the second surface of the solar energy collecting component.

7. An electronic device comprising:
a device body;
a battery mounted to the device body, the battery having a battery connector; and
a solar energy device mounted to the device body, the solar energy device comprising:
a solar energy collecting component; and
a lens module, the lens module being configured for concentrating incident solar radiation to the solar energy collecting component;
wherein the solar energy collecting component is configured for converting incident solar radiation energy to electrical energy and is electrically connected with the battery connector, and the lens module is rotatable relative to the solar energy collecting component.

8. The electronic device as claimed in claim 7, further comprising a rotating pole, wherein one end of the rotating pole is mounted on the solar energy collecting component and is rotatable relative to the solar energy collecting component, and the other end of the rotating pole is mounted on the lens module and is rotatable relative to the lens module.

9. The electronic device as claimed in claim 7, wherein the solar energy collecting component has a first surface and a second surface, and the lens module is rotatable relative to the solar energy collecting component such that the lens module has a first position in which the lens module is above the first surface of the solar energy collecting component and a second position in which the lens module is above the second surface of the solar energy collecting component.

10. The electronic device as claimed in claim 9, wherein the first surface of the solar energy collecting component is opposed to the second surface of the solar energy collecting component.

11. A solar energy device comprising:
a solar energy collecting component; and
a lens module, the lens module being configured to concentrate incident solar radiation onto the solar energy collecting component;
wherein the solar energy collecting component is configured for converting incident solar radiation energy into electrical energy, and the lens module is movably mounted relative to the solar energy collecting component.

12. The solar energy device as claimed in claim 11, wherein the solar energy device comprises a rotating pole having two opposite pole ends, one pole end is mounted to the solar energy collecting component and is rotatable relative to the solar energy collecting component, and the other pole end is mounted to the lens module and is rotatable relative to the lens module.

13. The solar energy device as claimed in claim 12, wherein the solar energy collecting component comprises a first mounting shaft the lens module comprises a second mounting shaft, the rotating pole defines a pair of mounting holes, the first and second mounting shafts engage in their corresponding mounting holes.

14. The solar energy device as claimed in claim 12, further comprising a positioning pole, wherein one end of the positioning pole is mounted to the solar energy collecting component and is rotatable relative to the solar energy collecting component, and the other end of the positioning pole is engageable with the lens module so as to position the lens module with respect to the solar energy collecting component.

15. The solar energy device as claimed in claim 14, wherein the positioning pole defines a positioning hole in the other end thereof, the lens module comprises a positioning projection thereon, and the positioning projection is configured to be engaged in the positioning hole thereby holding the lens module.

16. The solar energy device as claimed in claim 11, wherein the lens module is a Fresnel lens module.

17. The solar energy device as claimed in claim 11, further comprising a plug connector, wherein the plug connector is electrically connected with the solar energy collecting component, and is configured for electrically connecting with an electronic device.

18. The solar energy device as claimed in claim 11, wherein the lens module is movable between a first position and a second position, in the first position the lens module concentrates incident solar radiation onto the solar energy collecting component, and the overall volume of the solar energy device in the first position is greater than that in the second position.
